(19) United States
(12) Patent Application Publication
(10) Pub. No.: US 2013/0263731 A1
(43) Pub. Date: Oct. 10, 2013

(54) MOVEMENT RESTRICTING FIREARM MOUNT FOR VEHICLE AND METHOD OF ASSEMBLING

(71) Applicant: Gregory Lee Allen, Hallsville, MO (US)

(72) Inventor: Gregory Lee Allen, Hallsville, MO (US)

(21) Appl. No.: 13/441,520

(22) Filed: Apr. 6, 2012

(51) Int. Cl. F41A 23/00; B23P 11/00

(52) U.S. Cl. 89/37.13; 29/434

(57) ABSTRACT

A mount for use with a firearm is provided. The mount includes a base comprising an inner edge comprising a slot defined therein. A shaft comprising a first end, a second end, and a body therebetween is provided. The shaft extends through the slot, the first end being rotatably coupled to the base about a first axis. The inner edge restricts rotation of the shaft. A firearm support is provided comprising a first portion configured to couple to the second end of the shaft, and a second portion removeably coupled to the firearm.

### BACKGROUND OF THE INVENTION

The field of the invention relates generally to mounts, and more particularly, to a device for use in mounting a paintball gun to a trailer.

Shooting games have become increasingly popular. Some guns shoot ammunition commonly referred to as paintballs. The guns typically fire paintballs using compressed air, CO₂, or nitrogen to provide the motive force necessary to propel the paintballs. The paintballs themselves are often a spherical shell filled with non-toxic, water soluble and biodegradable paint. When a person or target is hit with a paintball, the paintball ruptures covering the target with evidence of being hit without severe damage or injury to the target or person hit. In some games involving large groups of people, participants may inadvertently point their paintball guns in a direction not intended for the game, causing injury to other participants or damage to nearby equipment or objects.

### BRIEF DESCRIPTION OF THE INVENTION

In one embodiment, a mount is provided for use with a firearm. The mount includes a base including an inner edge that includes a slot defined therein. A shaft including a first end, a second end, and a body therebetween extends through the slot. The first end is rotatably coupled to the base about a first axis. The inner edge restricts rotation of the shaft. A firearm support includes a first portion configured to couple to the second end of the shaft, and a second portion removeably coupled to the firearm.

In another embodiment, a firearm system is provided. The system includes a platform having a floor and a frame railing coupled to the floor. At least one firearm mount including a firearm support is coupled to the frame railing and is operable to adjust the horizontal angle and the vertical angle of the firearm support. The at least one firearm mount restricts the horizontal and vertical movement of the firearm support.

In yet another embodiment, a method is provided for assembling a firearm mount. The method includes providing a base that includes an inner edge including a slot defined therein. A shaft having a first end, a second end, and a body therebetween is provided. The first end of the shaft is coupled to the base for rotational movement about a first axis. The shaft body extends through the slot. A firearm support is coupled to the second end of the shaft for rotational movement about the shaft. The firearm support is operable to removeably couple to a firearm. A restrictor is provided to restrict the rotational movement of the firearm support.

The features, functions, and advantages described herein may be achieved independently in various embodiments of the present disclosure or may be combined in yet other embodiments, further details of which may be seen with reference to the following description and drawings.

### BRIEF DESCRIPTION OF THE DRAWINGS

FIG. 1 is a perspective view of an exemplary firearm mount system;

FIG. 2 is a perspective view of another firearm mount system; and

FIG. 3 is a perspective view of an exemplary firearm mount that may be used with the firearm mount systems shown in FIGS. 1 and/or 2.

Although specific features of various embodiments may be shown in some drawings and not in others, this is for convenience only. Any feature of any drawing may be referenced and/or claimed in combination with any feature of any other drawing.

### DETAILED DESCRIPTION OF THE INVENTION

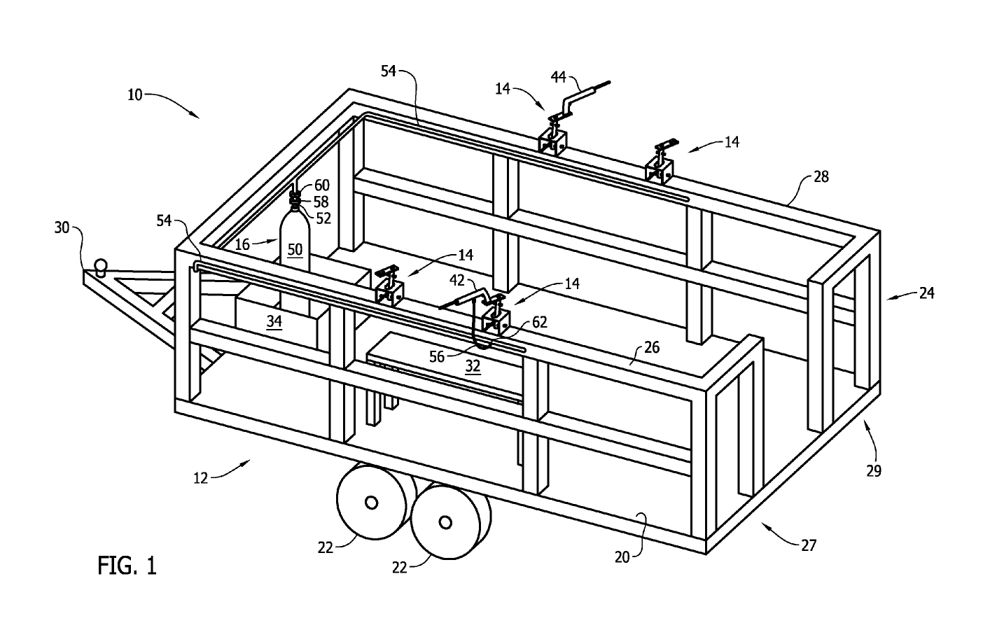

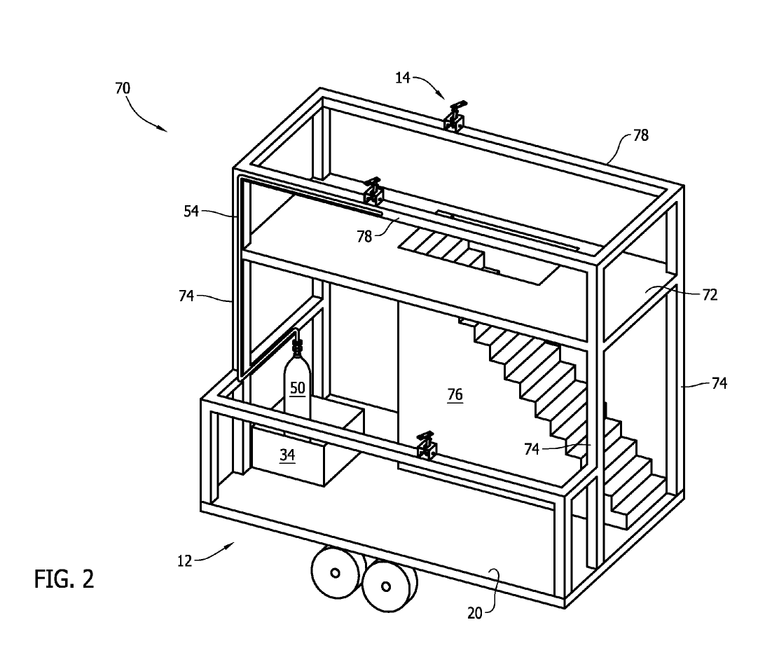

FIG. 1 illustrates an exemplary mobile firearm mount system 10. As used herein, “firearm” may refer to any device and/or mechanism that launches a projectile, particularly at a high velocity. In the exemplary embodiment, system 10 is used to transport participants (not shown) during a paintball related game. Generally, system 10 includes a mobile firing platform 12, at least one firearm mount 14, and an optional pressurized gas supply system 16. Mount 14 is operable, as described in more detail below, to restrict vertical and horizontal rotation of firearms (shown in FIGS. 1 and 2) attached thereto.

In the exemplary embodiment, firing platform 12 is a trailer that includes a floor 20 supported by wheels 22. Alternatively, firing platform 12 may be self-propelled. Depending on the load to be carried by floor 20, additional wheels 22 can be provided. Platform 12 also includes a railing 24 extending about a perimeter of the floor 20, and includes a first top rail 26 on one side 27 of platform 12 and a second top rail 28 on an opposite side 29 of platform 12. A plurality of firearm mounts 14 are coupled to top rail 26 and/or 28. Firearm mounts 14 are oriented and sized to receive and support a firearm 42 for use by an onboard passenger. Firearm 42 is, for example, a paintball gun, but mount 14 is not limited to only being used with firearm 42 or a paintball gun. In the exemplary embodiment, each of the top rails 26 and 28 can accommodate ten firearm mounts 14 and associated firearms 42. In another embodiment, each of the top rails 26 and 28 can accommodate twenty firearm mounts. Alternatively, any number of firearm mounts 14 may be used as long as rails 26 and/or 28 have space available to enable movement of firearms 42 without hindering passengers or the operation of adjacent firearms 42.

In the exemplary embodiment, platform 12 also includes a hitch connection 30 that enables attachment to a vehicle (not shown) such as a tractor, a bench 32 for passenger seating, and at least one pressurized gas tank storage container 34.

In the exemplary embodiment, pressurized gas supply system 16 includes a pressurized gas storage tank 50 including a hose 52 coupled to a main pressurized gas supply line 54. In the exemplary embodiment, tank 50 is secured within tank storage container 34. Gas supply line 54 is coupled to railing 24 to be in a position that is relatively close to each firearm mount 14, and to each firearm 42. A plurality of pressurized gas firearm supply lines 56 extend from gas supply line 54 to couple with each firearm 42 to provide the motive force to propel firearm ammunition. Although a main pressurized gas supply line 54 with multiple pressurized gas firearm supply lines 56 is described, any number of lines 54 and lines 56 may be had that enable system 16 to function as described herein.

In the exemplary embodiment, pressurized gas storage tank 50 is a 3,000 psi tank that contains compressed air. Alternatively, any suitable tank or device for storing any pressurized gas is contemplated. Further, any gas suitable for propelling a projectile may be used, such as carbon dioxide, nitrogen, or the like.

Pressurized gas supply system 16 also includes a regulator 58 that controls the pressure of the pressurized gas to ensure the safety tolerances for the firearms 42 are not exceeded, and a shutoff valve 60 that enables the main pressurized gas supply line 54 to be selectively disconnected. Supply lines 56 also each include a quick disconnect 62 that enables fluid communication between firearms 42 and the main pressurized gas supply line 54 to be quickly disconnected, for example to replace a malfunctioning firearm 42.

FIG. 2 illustrates an alternative mobile firearm mount system 70. System 70 is similar to mobile system 10 and identical reference numbers are used to identify the same components in FIG. 2 as were used in FIG. 1. Accordingly in FIG. 2, system 70 is similar to system 10 (shown in FIG. 1), except system 70 includes a second level 72. Generally, in the exemplary embodiment, system 70 includes a mobile firing platform 12, a firearm mount 14, a pressurized gas supply system 16, and an elevated platform 72.

In the exemplary embodiment, platform 72 is supported on floor 20 via support posts 74. A set of steps 76 extend from floor 20 to platform 72 to enable passenger access to platform 72. Platform 72 also includes a railing 78 extending about a perimeter of platform 72. Platform 72 is sized to accommodate any number of firearm mounts 14 and respective firearms 42. Main pressurized gas supply line 54 is coupled to second railing 78 to provide pressurized gas to firearm supply lines 56 and to firearms 42 coupled to railing 78. Alternatively, an additional pressurized gas tank and main pressurized gas supply line (not shown) may be used to provide pressurized gas to firearms 42 accessible from platform 72.

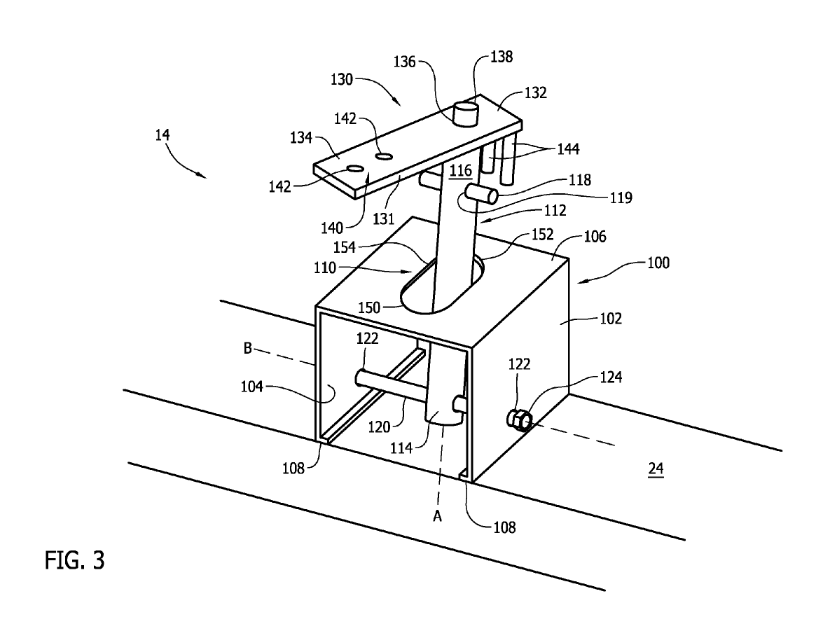

FIG. 3 is a perspective view of an exemplary firearm mount 14 that may be used with systems 10 and 70 (shown in FIGS. 1 and 2, respectively). Generally, mount 14 includes a base 100, a shaft 112, and a firearm support 130.

In the exemplary embodiment, base 100 is generally U-shaped and includes first and second opposed walls 102 and 104 coupled together by a third wall 106. Flanges 108 are provided at the ends of walls 102 and 104, opposite third wall 106 to facilitate increasing the surface area used to couple base 100 to railing 24 or other object. Alternatively, flanges 108 can accept an insert (not shown) that is bolted to railing 24 to secure mount 14 thereto. Third wall 106 includes an inner edge 154 that defines a slot 110. In the exemplary embodiment, base 100 is fabricated from metal, plastic, or any other suitable material, and can be coupled to railing 24 using any suitable fastening means, such as for example via welding, an adhesive, a mechanical coupler, etc. Although base 100 is described in the exemplary embodiment as being generally U-shaped, various other shapes and configurations are contemplated to be within the scope of the invention.

In the exemplary embodiment, shaft 112 is a generally cylindrical body having a first end 114, a second end 116, and a shaft-pin 118. Shaft 112 includes a longitudinal axis A that extends from end 114 to end 116. Shaft 112 is slightly smaller in diameter 113 than slot 110 and extends through slot 110 such that shaft end 114 is positioned between first and second opposed walls 102 and 104, respectively, and such that shaft end 116 extends a distance above base 100. Shaft 112 can be fabricated from any suitable material such as, for example, metal or plastic.

In the exemplary embodiment, shaft 112 has a length 160 that is between approximately 1.0 and approximately 3.0 inches. More particularly, in the exemplary embodiment, length 160 is between approximately 2.25 and approximately 2.5 inches. In the exemplary embodiment, shaft 112 has a diameter 162 that is between approximately 0.25 inches and approximately 1.0 inch. More particularly, diameter 162 is approximately 0.5 inches. Alternatively, shaft 112 may have any length and/or diameter that enables it to function as described herein. Although shaft 112 is described in the exemplary embodiment as being generally cylindrical, various other shapes and configurations are contemplated to be within the scope of the invention.

In the exemplary embodiment, shaft-pin 118 extends through a portion of shaft 112 above slot 110. In the exemplary embodiment, shaft-pin 118 is substantially perpendicular to shaft axis A. Shaft-pin 118 is coupled to shaft 112 via any suitable means such as, for example, by welding. Alternatively, shaft-pin 118 can be an integral projection extending outward from shaft 112. In the exemplary embodiment, shaft-pin 118 has a diameter 164 of between approximately 0.125 inches and approximately 0.625 inches. More particularly, in the exemplary embodiment, diameter 164 is approximately 0.25 inches. In the exemplary embodiment, shaft-pin 118 has a length 166 that is between approximately 0.5 inches and 2 inches. More particularly, in the exemplary embodiment, length 166 is approximately 1.25 inches. Alternatively, shaft-pin 118 may have any length and/or diameter that enables is to function as described herein.

Shaft 112 is rotatably coupled to base 100 by a pin 120. Pin 120 extends through apertures 122 formed in first and second walls 102 and 104, respectively, to provide rotation about an axis B. In the exemplary embodiment, pin 120 has a diameter 168 that is between approximately 0.125 inches and approximately 0.625 inches. More particularly, in the exemplary embodiment, diameter 168 is approximately 0.25 inches. In the exemplary embodiment, apertures 122 have a diameter 170 that is approximately between approximately 0.125 inches and approximately 0.875 inches. More particularly, in the exemplary embodiment, diameter 170 is approximately 0.25 inches. Alternatively, pin 120 and/or apertures 122 may have any diameter that enables pin 120 to rotate within apertures 122. In the exemplary embodiment, pin 120 is a bolt secured to base 100 by a nut 124.

In the exemplary embodiment, support 130 has a generally rectangular body 131 that includes a first portion 132, a second portion 134, and aperture 136 formed in first portion 132. Support 130 may be fabricated from any suitable material such as, for example, metal, plastic, or the like. In the exemplary embodiment, support aperture 136 receives a threaded bolt 138 that rotatably couples support 130 to shaft end 116. Bolt 138 couples to shaft end 116 and enables firearm support 130 to selectively rotate about axis A.

In the exemplary embodiment, support 130 has a length 172, a width 174, and a thickness 176. In the exemplary embodiment, length 172 is between approximately 2.0 inches and approximately 4.0 inches. More particularly, in the exemplary embodiment, length 172 is approximately 3.0 inches. In the exemplary embodiment, width 174 of support 130 is between approximately 0.5 inches and approximately 2.0 inches. More particularly, width 174 is approximately 1.0 inch. In the exemplary embodiment, thickness 176 of support 130 is between approximately 0.125 inches and approximately 0.875 inches. More particularly, in the exemplary embodiment, thickness 176 is approximately 0.375 inches. Alternatively, support 130 may have any length, width and/or thickness that enables it to function as described herein. In the exemplary embodiment, aperture 136 has a diameter 178 that is between approximately 0.125 inches and approximately 0.625 inches. More particularly, in the exemplary embodiment, diameter 178 is approximately 0.375 inches. Alternatively, aperture 136 may have any diameter that enables it to function as described herein.

Firearm support 130 also includes a support face 140 that is formed with apertures 142 therein. In the exemplary embodiment, apertures 142 receive one or more bolts (not shown) that secure firearm 42 to face 140. Moreover, in the exemplary embodiment, support 130 also includes a pair of projections 144 that extend downwardly from first portion 132. Alternatively, projections 144 can be formed as a single integral projection. Projections 144 contact shaft-pin 118 to restrict rotational movement of support 130, as is described in more detail below. Although firearm support 130 is described in the exemplary embodiment as generally rectangular, various other shapes and configurations are contemplated to be within the scope of the invention.

In the exemplary embodiment, apertures 142 have a diameter 180 that is between approximately 0.125 inches and approximately 0.625 inches. More particularly, in the exemplary embodiment, diameter 180 is approximately 0.25 inches. Alternatively, apertures 142 may have any diameter that enable them to function as described herein. In the exemplary embodiment, projections 144 have a diameter 182 that is between approximately 0.125 inches and approximately 0.375 inches. More particularly, in the exemplary embodiment, diameter 182 is approximately 0.25 inches. Alternatively, projections 144 may have any diameter that enables them to function as described herein.

During operation, passengers board firing platform 12 and are positioned to operate a firearm 42 coupled to a mount 14. Pressurized gas supplied to firearms 42 via supply system 16 enables the passengers to fire projectiles at targets as mobile firing platform 12 is moved.

Firearm mount 14 restricts the range of motion of firearm support 130 and restricts the range of motion of each associated firearm 42. Several reasons for limiting the range of motion of firearms 42 are to prevent adjacent guns from contacting one another, to prevent damage to adjacent firearms caused by the flying projectiles, and to prevent injury to bystanders or passengers operating the firearms.

The vertical angular movement (i.e., the up and down movement) of each firearm support 130, and thus the vertical angular movement of each firearm 42, is restricted by rotation of shaft 112 in slot 110. As shaft 112 rotates about axis B and shifts forward in slot 110 (i.e., away from the firearm operator), the forward motion is restricted by a first slot end 150. This position corresponds to the lower vertical angle limit of firearm 42 with respect to the horizon, wherein a barrel 44 of firearm 42 is generally pointed towards the ground. As shaft 112 rotates backward in slot 110 (i.e., towards the operator), the backward motion of the firearm 42 is restricted by a second slot end 152. This position corresponds to the upper vertical angle limit of firearm 42 with respect to the horizon, wherein barrel 44 is pointed generally upwards. Thus, first and second slot ends 150 and 152 of slot 110 limit vertical movement of firearm 42. Advantageously, the vertical angular movement can be adjusted by varying a length of slot 110 or a distance of pin 120 from third wall 106.

The horizontal angular movement (i.e., side to side movement) of each firearm support 130, and thus the horizontal angular movement of each firearm 42, is restricted by contact between shaft-pin 118 and projections 144. Shaft-pin 118 functions as a first rotational restrictor, and projections 144 function as a second rotational restrictor. As support 130 rotates towards the left, relative to an operator, one projection 144 contacts shaft-pin 118, thereby preventing movement of support 130 and firearm 42. This position corresponds to the maximum angular movement to the left of the operator. As support 130 rotates towards the right, relative to an operator, the other projection 144 contacts shaft-pin 118, thereby preventing movement of firearm support 130 and firearm 42. This position corresponds to the maximum angular movement to the right of the operator. Thus, shaft pin 118 and projections 144 cooperate to limit horizontal movement of firearm 42. Advantageously, the horizontal angular movement can be adjusted by changing the location of shaft-pin 118 and/or projections 144, thereby adjusting the relative position of when projections 144 will contact shaft-pin 118.

In the exemplary embodiment, during fabrication, initially a base 100 is formed having an inner edge 154 that defines a slot 110, and apertures 122. A shaft 112 including an aperture 119 is provided, where a second end 116 of the shaft 112 is threaded to accept a threaded bolt 138. A firearm support 130 is provided including a support aperture 136 to accept threaded bolt 138, and at least one firearm connection aperture 142. One or more projections 144 are coupled to support 130.

Shaft 112 having a first end 114, second end 116, and a body therebetween is inserted into slot 110. Shaft end 114 is rotatably coupled to base 100 for rotational movement about a first axis B by inserting pin 120 through shaft aperture 119 and apertures 122 formed in first and second walls 102 and 104, respectively. Support 130 is rotatably coupled to shaft end 116 by bolt 138 for rotational movement about a longitudinal axis A of the shaft. Further, a firearm 42 is coupled to the support 130 by providing a fastener through firearm connection aperture 142.

As described above, a mobile firearm mount system is provided. The mobile system provides a way to transport multiple passengers for a game in which paintball guns are used. The mobile system provides one convenient location to supply each passenger with a firearm, paintballs and pressurized gas to propel the paintballs. Further, an improved firearm mount is described. The firearm mount provides a secure attachment for a firearm and ease of use for an operator. The mount provides both horizontal and vertical rotation restriction to limit the directional range paintballs can be shot to prevent damage to adjacent equipment and injury to the operator and nearby persons.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A mount for use with a firearm, said mount comprising:
a base comprising an inner edge comprising a slot defined therein;
a shaft comprising a first end, a second end, and a body therebetween, said shaft extending through said slot, said first end rotatably coupled to said base about a first axis, said inner edge restricts rotation of said shaft; and
a firearm support comprising a first portion configured to couple to said second end of said shaft, and a second portion to removeably couple to said firearm.

2. The mount of claim 1, further comprising a first restrictor extending from said shaft body, said restrictor configured to restrict movement of said firearm support about said shaft.

3. The mount of claim 2, further comprising a second restrictor coupled to said first end portion of said firearm support, said second restrictor configured to selectively engage said first restrictor to limit rotation of said firearm support about said shaft.

4. The mount of claim 1, further comprising a pin that rotatably couples said shaft to said base.

5. The mount of claim 2, wherein said first restrictor comprises at least one pin extending from said shaft.

6. The mount of claim 3, wherein said second restrictor comprises at least one pin extending from said first portion of the firearm support.

7. A firearm system comprising:
a platform having a floor;
a frame railing coupled to said floor;
at least one firearm mount including a firearm support, said firearm mount coupled to said frame railing and operable to adjust the horizontal angle and the vertical angle of said firearm support; and
wherein said at least one firearm mount restricts the horizontal and vertical movement of said firearm support.

8. The firearm system of claim 7, further comprising a pressurized gas supply system configured to supply pressurized gas towards said at least one firearm mount.

9. The firearm system of claim 8, wherein said pressurized gas supply system further comprises a pressurized gas tank having a main pressurized gas supply line extending therefrom; and
a pressurized gas firearm supply line extending from said main pressurized gas supply line to said firearm mount.

10. The firearm system of claim 7, further comprising an elevated platform coupled to and located above said floor, said elevated platform including a second frame railing.

11. The firearm system of claim 7, wherein at least ten firearm mounts are coupled to said frame railing.

12. The firearm system of claim 7, wherein at least twenty firearm mounts are coupled to said frame railing.

13. The firearm system of claim 7, wherein at least ten firearm mounts are coupled to said frame railing on a first side of said floor and at least ten firearm mounts are coupled to said frame railing on a second side of said floor.

14. The firearm system of claim 10, wherein at least ten firearm mounts are coupled to said second frame railing.

15. A method of assembling a firearm mounting system, said method comprising:
providing a base comprising an inner edge comprising a slot defined therein;
providing a shaft having a first end, a second end, and a body therebetween;
coupling the first end of the shaft to the base for rotational movement about a first axis, the shaft body extending through the slot;
coupling a firearm support to the second end of the shaft for rotational movement about the shaft, the firearm support operable to removeably couple to a firearm; and
providing a restrictor to restrict the rotational movement of the firearm support.

16. The method of claim 15, wherein said coupling of the shaft to the base further comprises the steps of:
coupling a pin to the base for rotational movement; and
coupling the first end of the shaft to the pin.

17. The method of claim 15, wherein said providing the restrictor comprises:
providing a shaft-pin through the body of the shaft between the slot and the firearm support;
providing at least one projection from the firearm support to facilitate selective engagement of the projection with the shaft-pin to limit the rotational movement of the firearm support.
